(19) United States
(12) Patent Application Publication
(10) Pub. No.: US 2010/0253768 A1
(43) Pub. Date: Oct. 7, 2010

(54) APPARATUS AND METHOD FOR GENERATING AND DISPLAYING A STEREOSCOPIC IMAGE ON A MOBILE COMPUTING DEVICE

(75) Inventors: Thomas F. El-Maraghi, Hawkestone (CA); Bernhard Dietrich Schipper, Leipzig (DE); James G. Hurley, Aurora (CA); Marco Zichner, Dresden (DE); David Rost, Dresden (DE); Rolf-Dieter Naske, Kakenstorf (DE); Wolfgang Opel, Berlin (DE); Steffen Boettcher, Dresden (DE); Klaus Kesseler, Medebach (DE); Roger Dass, Aurora (CA)

Correspondence Address: Soquel Group, LLC, P.O. Box 691, Soquel, CA, 95073, US

(73) Assignee: Spatial View Inc., Toronto (CA)

(21) Appl. No.: 12/729,655

(22) Filed: Mar. 23, 2010

Related U.S. Application Data
(60) Provisional application No. 61/162,566, filed on Mar. 23, 2009.

(51) Int. Cl. H04N 13/04; G06F 3/041

(52) U.S. Cl. 348/51; 345/173

(57) ABSTRACT

An apparatus and method for generating and displaying a stereoscopic image on a mobile computing device. The apparatus includes an autostereoscopic overlay which is secured over at least a portion of the screen of the mobile computing device, such as by using a case. Computer-readable instructions are executed on the mobile computing device to align two captured images, if necessary, and interlace them into an interlaced image for subsequent display to the screen of the mobile computing device. When the displayed image is viewed by the user of the mobile computing device through the autostereoscopic overlay, the image appears as a stereoscopic (or three-dimensional) image.

### FIELD OF THE APPLICATION

The present application relates to stereoscopic image visualization, and more particularly, to an apparatus and method for generating and displaying a stereoscopic image on a mobile computing device.

### BACKGROUND OF THE APPLICATION

Stereoscopic image visualization has become increasingly popular in recent years and may be desirable in applications other than three-dimensional (3D) movies.

Mobile computing devices, such as mobile gaming devices, handheld personal computers (PCs), and mobile phones, now have considerable processing power but are typically equipped with standard, flat two-dimensional (2D) displays. Many such mobile devices, such as cell phones, are also equipped with cameras.

Accordingly, there remains a need for improvements in the art with respect to stereoscopic image visualization and mobile devices.

### BRIEF SUMMARY OF THE INVENTION

According to one aspect, the present invention provides a mobile computing device configured to display a stereoscopic image to a user, comprising: a screen; an autostereoscopic overlay over at least a portion of the screen; a processor; a computer-readable memory; and computer-readable instructions stored on the computer-readable memory which when executed by the processor display an interlaced image to the screen such that the interlaced image appears to the user as the stereoscopic image when the screen is viewed through the autostereoscopic overlay.

According to a further aspect, the present invention provides a kit for enabling the display of stereoscopic images on a mobile computing device comprising a screen, a processor and a computer-readable memory containing computer-readable instructions which when executed by the processor display an interlaced image to the screen such that the interlaced image appears to the user as a stereoscopic image when the screen is viewed through an autostereoscopic overlay, comprising: the autostereoscopic overlay for the mobile computing device; and a case for securing the autostereoscopic overlay over at least a portion of the screen of the mobile computing device.

According to a further aspect, the present invention provides a method for using a mobile computing device to generate and display an interlaced image so that it appears as a stereoscopic image when viewed through an autostereoscopic overlay by a user of the mobile computing device, the mobile computing device comprising a screen, a processor, a computer-readable memory and an autostereoscopic overlay secured over at least a portion of the screen, comprising: capturing two images; interlacing the two images so that the interlaced image will appear as a stereoscopic image when viewed through an autostereoscopic overlay; and displaying the interlaced image to the screen of the mobile device.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the methods, systems and apparatus described herein, and how they may be carried into effect, and in which:

FIG. 1 shows in diagrammatic form an autostereoscopic generation and viewing architecture according to an embodiment;

FIG. 2 shows an autostereoscopic overlay and a case before integration according to an embodiment;

FIG. 3 shows in diagrammatic form gestures to shift an image according to an embodiment;

FIG. 4 shows in diagrammatic form gestures to reduce image size horizontally according to an embodiment;

FIG. 5 shows in diagrammatic form gestures to expand image size horizontally according to an embodiment;

FIG. 6 shows in diagrammatic form gestures to reduce image size vertically according to an embodiment;

FIG. 7 shows in diagrammatic form gestures to expand image size vertically according to an embodiment;

FIG. 8 shows in diagrammatic form gestures to rotate an image clockwise according to an embodiment;

FIG. 9 shows in diagrammatic form gestures to rotate an image counterclockwise according to an embodiment;

FIG. 10 shows in diagrammatic form gestures to move the viewing direction up or down according to an embodiment;

FIG. 11 shows in diagrammatic form gestures to move the viewing direction left or right according to an embodiment;

FIG. 12 shows a case for an autostereoscopic overlay according to an embodiment;

FIG. 13 shows a further embodiment of a case for an autostereoscopic overlay;

FIG. 14 shows an autostereoscopic overlay being secured by the case shown in FIG. 13, according to an embodiment;

FIG. 15 shows an autostereoscopic overlay secured by the case shown in FIG. 13, according to an embodiment;

FIG. 16 shows a mobile computing device integrated with a case according to an embodiment;

FIG. 17 shows an autostereoscopic overlay being secured by the case over the screen of the mobile computing device shown in FIG. 16, according to an embodiment;

FIG. 18 shows an autostereoscopic overlay secured by the case over the screen of the mobile computing device shown in FIG. 16, according to an embodiment;

FIG. 19 shows an autostereoscopic overlay secured by a case according to a further embodiment;

FIG. 20 shows an embodiment of a mobile computing device;

FIG. 21 shows the mobile computing device of FIG. 20 integrated with the case of FIG. 19, according to an embodiment;

FIG. 22 shows the mobile computing device of FIG. 20 integrated with the case of FIG. 19 with the autostereoscopic overlay over the screen of the mobile computing device, according to an embodiment;

FIG. 23 shows a protective cover being integrated with a frame according to an embodiment;

FIG. 24 shows a protective cover integrated with a frame according to an embodiment;

FIG. 25 shows a mobile computing device being integrated with a protective cover and a frame according to a further embodiment;

FIG. 26 shows a mobile computing device integrated with a protective cover and a frame according to an embodiment;

FIG. 27 shows a protective cover integrated with an autostereoscopic overlay according to an embodiment;

FIG. 28 shows a mobile computing device being integrated with the protective cover and integrated autostereoscopic overlay of FIG. 27 according to an embodiment;

FIG. 29 shows a mobile computing device integrated with the protective cover and integrated autostereoscopic overlay of FIG. 27 according to an embodiment;

FIG. 30 shows a protective cover with an integrated autostereoscopic overlay according to an embodiment;

FIG. 31 shows an embodiment of a mobile computing device;

FIG. 32 shows the mobile computing device of FIG. 31 integrated with the protective cover and integrated autostereoscopic overlay of FIG. 30; and

FIG. 33 shows the mobile computing device of FIG. 31 integrated with a case and an autostereoscopic overlay according to a further embodiment.

Like reference numerals indicate like or corresponding elements in the drawings.

### DETAILED DESCRIPTION OF THE EMBODIMENTS

Embodiments of the present invention are generally directed to an apparatus and method for generating and displaying a stereoscopic image on a mobile computing device.

According to an embodiment, the autostereoscopic screen overlay may be adaptable so that it may be used with various mobile computing devices such as mobile gaming devices, handheld PCs, mobile phones and other mobile computing devices.

According to an embodiment, a stereoscopic image may be generated and viewed using a mobile computing device, which may include a camera, by providing an autostereoscopic screen overlay for the standard, flat 2D display of the mobile device, and by providing supporting software and, optionally, communication infrastructure.

According to an embodiment, the following is provided:

1. 3D Capturing and Adjustment

When the user of a mobile device wants to capture images in 3D, he may use a stereo camera or may capture two images in sequence. If images are captured in sequence an adjustment method may be used to generate a stereoscopically correct image. A method for gesture-driven stereo image adjustment for mobile devices having a touch-screen interface is discussed below.

2. 3D Interlacing

For autostereoscopic displays the stereo image is interlaced for correct viewing. A tool is described below to support this interlacing process.

3. Autostereoscopic Overlay

If the display is not an autostereoscopic display, an overlay may be provided to enhance the display. Different overlay designs are described below.

4. 3D Loading and Viewing

Captured or received stereo images may be stored in a data store, such as a database, and subsequently loaded to a mobile device for viewing.

According to an embodiment, where a stereo camera is not available, an integrated mono camera may be used to capture a stereo image as long as the two captured images satisfy quality and consistency criteria. An example of quality and consistency criteria is the normalized stereo image format, which provides that a stereo image consisting of two 2D images is captured with horizontally and vertically parallel lenses and identical optical parameters. This means that the viewing direction of both lenses is horizontally and vertically parallel, that the image plane of both pictures is in the same distance from the observed objects and that the focal length of both lenses is identical. If this is the case a qualitatively acceptable stereo image pair may be expected. Other suitable quality criteria are well-known to a person skilled in the art.

If two 2D images are taken one shortly after the other with the integrated camera of a mobile device, a check may be made to ensure that the focal length is substantially identical. But, apart from motion, which might occur between the two shots, it is very unlikely that the lens has been positioned such that the viewing direction of the two images is horizontally and vertically parallel for both captured images. Thus, in many cases, image adjustment may be performed.

On some mobile phones and other mobile computing devices, a touch screen interface may be provided. An embodiment of the present invention provides a method of adjusting two captured 2D images to generate a stereo image of satisfactory quality and consistency using a touch screen for user command and control interaction on a suitably configured mobile device.

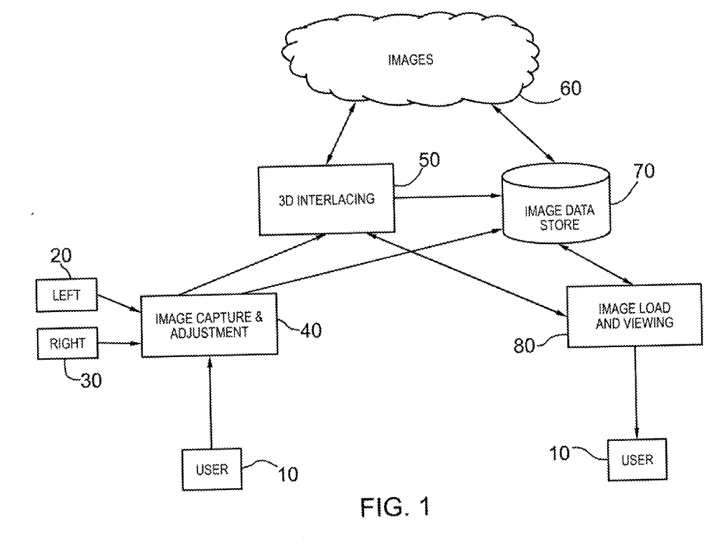

According to a further embodiment, a system for generating and viewing a stereo image may be provided. An embodiment of such a system is shown in FIG. 1. User 10 captures two 2D images, a left image 20 and a right image 30 or captures a 3D image with a 3D camera via the Image Capture & Adjustment component 40, which includes image adjustment as described below. The adjusted image may be either sent in a standard stereo format like side-by-side or over/under to a data store, such as Image Data Store 70, which may be a data store on the mobile device 350 itself or a data store connected to the mobile device 350 via a communication network, or is interlaced by a 3D Interlacing component 50, as described below. After interlacing, the 3D image may be sent to Image Data Store 70 or other 3D image storage media 60. 3D images received from other 3D image storage media 60 may be interlaced at 3D Interlacing component 50 and stored in the Image Data Store 70 or may be stored directly in a standard stereo format in the Image Data Store 70. Images in the Image Data Store 70 may be subsequently loaded from the data store and viewed by the user 10 via Image Load and Viewing component 80.

3D Capturing and Adjustment

If the mobile device 350 includes an integrated stereo camera, the two images 20 and 30 may be automatically adjusted. If two images 20 and 30 have been captured separately with a standard 2D camera of the mobile device 350 for composing a normalized stereo image, then deviations from the ideal format may be expected. Such deviations include:

1. One of the images may be closer to the scene than the other. This leads to a zoom in or zoom out effect. Objects in the scene do not have the same size in each image.

2. The images may not be shot horizontally parallel. The scene in both images is not identical.

3. The images may be shot too far away from each other. This leads to an unwanted high disparity, which may cause headache and eye strains as the brain is not able to merge corresponding image points (pixels) together.

4. The images may be rotated relative to each other.

5. One of the viewing directions may be more downward or upward than the other. In other words, the viewing directions are not vertically parallel.

6. One of the viewing directions may be more to the left or to the right than the other. In other words, the viewing directions are not horizontally parallel.

Once the two images 20 and 30 have been taken, they may be visualized on a display of a mobile device 350 in a certain stereo format such as an anaglyph, autostereoscopically interlaced, or shuttered. According to the embodiment described below, both images 20 and 30 may be displayed in an anaglyph format and only the right image 30 may be modified (while keeping the left image unchanged), although it is possible for the adjustment techniques described below to be applied to either or both left and right images 20 and 30 by allowing the user 10 to select an image before performing an adjustment operation.

Checking the horizontal borders of objects in the scene may identify a normalized stereo image. When overlaying two images 20 and 30 the horizontal borders of objects should be on the same pixel line of the display and should have the same size.

There are certain operations, which may be executed by the user 10 through a touch screen user interface of a mobile device 350 configured according to an embodiment of the invention to achieve good stereoscopic image quality. According to an embodiment, the user interface consists of gestures for coarse adjustments according to the motion of fingertips 100 and 105 on the image adjustment area of the touch screen and graphical buttons or icons for fine adjustments.

These operations are:

1. Shift:

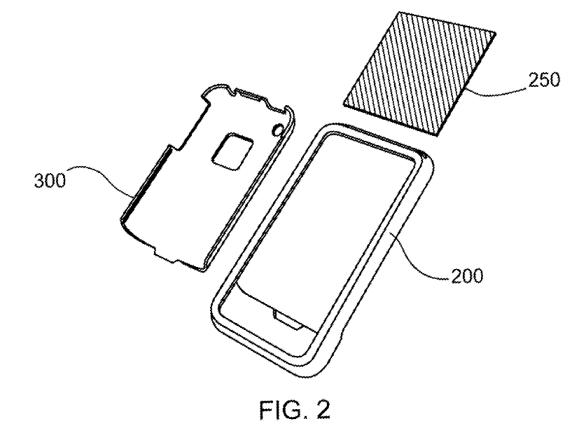

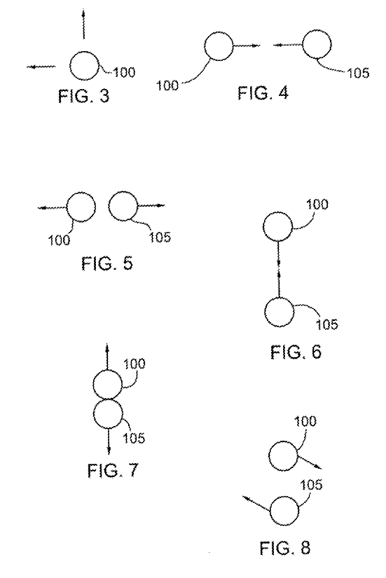

According to an embodiment as shown in. FIG. 3, the user 10 may touch the screen of the mobile device 350 with a single fingertip 100, and the mobile device is configured to sense the position of the fingertip 100. When moving the fingertip 100 in a certain direction, the right image 30 will be shifted in the same direction and with the same speed as the motion of the fingertip 100. When removing the fingertip 100 from the touch screen shifting of the image will stop. According to an embodiment, a shift operation may be configured to perform the following mathematical operation on the image:

I(x′,y′):=I(x+Delta_{—}x, y+Delta_{—}y) Equ. 1

Each pixel will be shifted by Delta_x and Delta_y in the horizontal or the vertical direction, as applicable.

The shift operation may allow the user 10 to horizontally align the borders of objects in the scene and to reduce or extend the vertical disparity of corresponding pixels in the left and right images 20 and 30.

According to an embodiment, the shift operation may also be performed by the user 10 pressing a graphical button or icon labeled “Shift”, and then by pressing graphical buttons or icons labeled “Up”, “Down”, “Left”, and “Right”. These buttons are configured to move the image the smallest allowable increment in the selected direction, allowing for precise adjustments that are difficult to achieve through touch control. Furthermore, the “Up”, “Down”, “Left”, and “Right” buttons may be displayed when the user 10 touches the image adjustment area of the touch screen with one fingertip 100, and remain visible until some other state of the user interface is invoked.

2. Scale:

According to embodiments as shown in FIGS. 4 to 7, the user 10 may touch the screen of the mobile device 350 with two fingertips 100 and 105, and the mobile device is configured to sense the position of fingertips 100 and 105. As shown in FIGS. 4 and 6, when moving fingertips 100 and 105 towards each other, the right image 30 will be reduced in size. As shown in FIGS. 5 and 7, when moving fingertips 100 and 105 away from each other, the right image 30 will be expanded. When removing fingertips 100 and 105 from the touch screen the scaling of the image will stop. According to an embodiment, a scale operation may be configured to perform the following mathematical operation on the image:

I(x′,y′):=I(x*Delta_{—}x, y*Delta_{—}y) Equ. 2

Each pixel position will be multiplied by Delta_x and Delta_y, which will be larger or smaller than 1 for scaling to occur.

Moving fingertips 100 and 105 towards each other will result in values of Delta_x and Delta_y smaller than 1. Moving fingertips 100 and 105 away from each other will result in values of Delta_x and Delta_y larger than 1.

The scale operation may allow the user 10 to ensure that objects in the left image 20 and right image 30 have the same size in the stereo image.

According to an embodiment, the scale operation may also be performed by the user 10 pressing a graphical button or an icon labeled “Scale”, and then by pressing graphical buttons or icons labeled “Larger” and “Smaller”. These buttons increase (or decrease, respectively) the size of the image by the smallest allowable increment, allowing for precise adjustments that are difficult to achieve through touch control. Furthermore, “Larger” and “Smaller” buttons may be displayed when the user 10 touches the image adjustment area of the touch screen with two fingertips 100 and 105, and remain visible until some other state of the user interface is invoked.

3. Rotate:

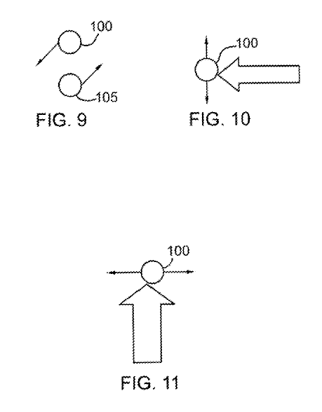

According to embodiments as shown in FIGS. 8 and 9, the user 10 may touch the screen of the mobile device 350 with two fingertips 100 and 105, and the mobile device is configured to sense the position of fingertips 100 and 105. But when rotating fingertips 100 and 105 clockwise, the right image 30 will be rotated clockwise. When rotating fingertips 100 and 105 counter clockwise, the right image 30 will be rotated counter clockwise. When removing fingertips 100 and 105 from the touch screen scaling the image will stop. According to an embodiment, a rotate operation may be configured to perform the following mathematical operation on the image:

I(x′,y′):=I(x*cos α−y*sin α, x*sin α+y*cos α) Equ. 3

Each pixel position will be rotated by an angle of α in the image plane Clockwise or counter clockwise rotation is distinguished by a positive or negative angle.

The rotate operation may allow the user 10 to compensate for rotated camera positions.

According to an embodiment, the rotate operation may also be performed by the user 10 pressing a graphical button or an icon labeled “Rotate”, and then by pressing graphical buttons or icons labeled “Clockwise” and “Counterclockwise”. These buttons rotate the image in the respective direction in the smallest allowable increment, allowing for precise adjustments that are difficult to achieve through touch control. Furthermore, “Clockwise” and “Counterclockwise” buttons are displayed when the user 10 touches the image adjustment area of the device with two fingertips 100 and 105, and remain visible until some other state of the user interface is invoked. Thus, the “Larger” and “Smaller” buttons from scale may be displayed simultaneously with the “Clockwise” and “Counterclockwise” buttons when the user 10 touches the adjustment area of the touch screen with two fingertips 100 and 105.

With these gesture-driven operations the user 10 may compensate for the above-mentioned deviations from the normalized stereo format as follows:

1. One of the images is closer to the scene than the other: apply the “Scale” operation horizontally and/or vertically, as shown in FIGS. 4 to 7.

2. The images are not shot horizontally parallel: apply the “Shift” operation horizontally and/or vertically, as shown in FIG. 3.

3. The images are shot too far away from each other: apply the “Shift” operation horizontally, as shown in FIG. 3.

4. The images are rotated in relation to each other: apply the “Rotate” operation clockwise or counter clockwise, as shown in FIGS. 8 and 9.

5. One of the viewing directions is more downward or upward than the other: apply the “Scale” operation vertically and then the “Shift” operation, as shown in FIG. 10.

6. One of the viewing directions is more to the left or to the right than the other: apply the “Scale” operation horizontally and then the “Shift” operation, as shown in FIG. 11

After having adjusted the two images 20 and 30, the stereo image may be loaded to the Image Data Store 70 in a standard stereo format or in an interlaced format.

3D Interlacing

According to an embodiment, after having captured or received a stereo image it may be in one of the standard stereo formats, for example, side-by-side, interlaced or over/under. For autostereoscopic viewing these formats may be converted to a format where usually the left and right images 20 and 30 are merged on a pixel or subpixel basis. One of the two perspectives may be assigned to each pixel or subpixels of the display.

During the interlacing process the pixels of the stereo image are taken and moved to the pixel position on the display where it may become visible.

The merged image may either completely cover the display of the mobile device 350 or the display may be divided into several action and viewing areas. According to an embodiment, the interlacing process may have to be adapted to the structure of the available mobile display. According to an embodiment, a video area may be used for displaying the interlaced stereo image whereas at the same time another area may be used for entering gesture driven control commands like scrolling or zooming.

The image resulting from the interlacing process may be stored in a data store such as Image Data Store 70 and may be loaded and viewed by any suitable mobile device 350 including an autostereoscopic display or an autostereoscopic overlay.

According to a further embodiment, more than two images may be generated from a given stereo pair as is described in U.S. Provisional Patent Application No. 61/272,583 entitled “Method and Process for the Automated Processing and Editing of Aligned and Non Aligned Images for the Creation of Two View and Multi View Stereoscopic Images”, which is incorporated by reference herein. These multiple images may be interlaced as described above by assigning one of the multiple perspectives to each pixel or subpixels of the display.

Autostereoscopic Overlay

As described, the mobile device 350 may be configured with autostereoscopic properties for glasses-free 3D viewing. If the display itself is not autostereoscopic, an autostereoscopic overlay 250 may be attached to it such that the correct positioning of the autostereoscopic overlay 250 in relation to the pixel or subpixel structure of the display is maintained. The autostereoscopic overlay 250 may be attached permanently or be removable.

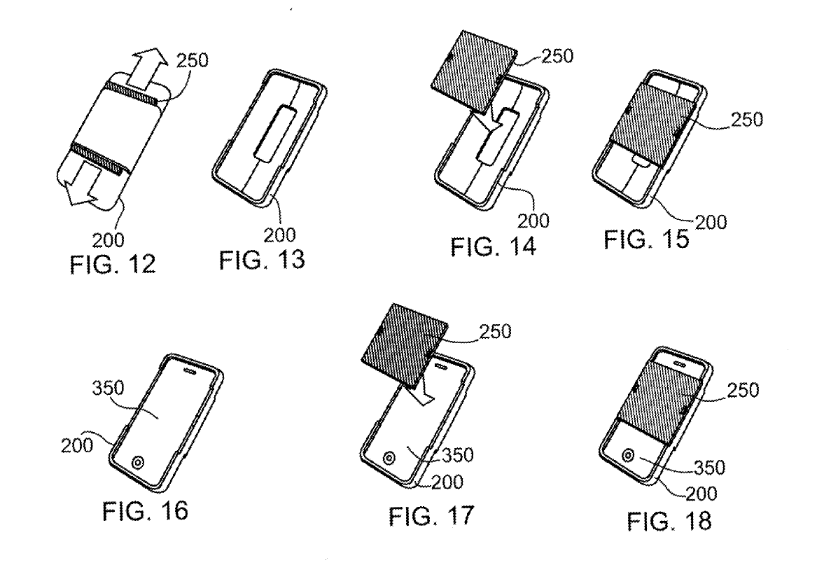

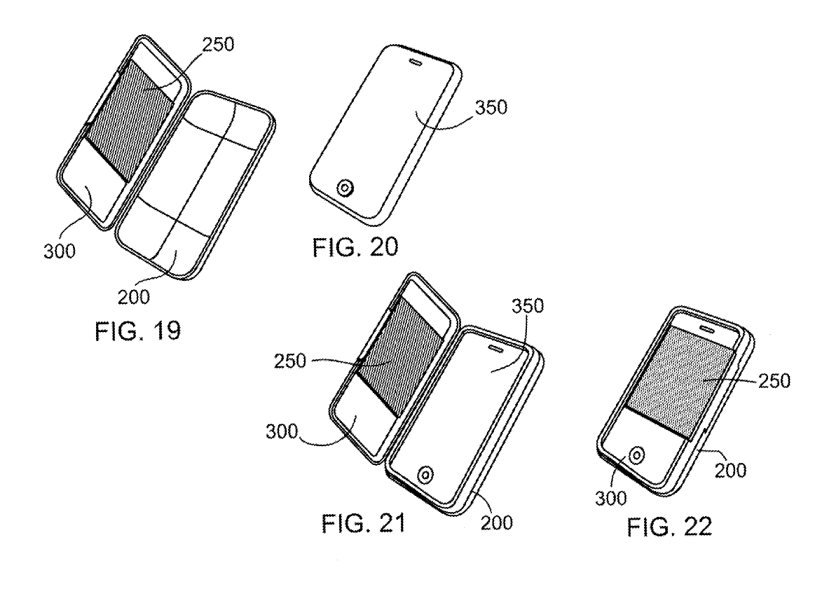

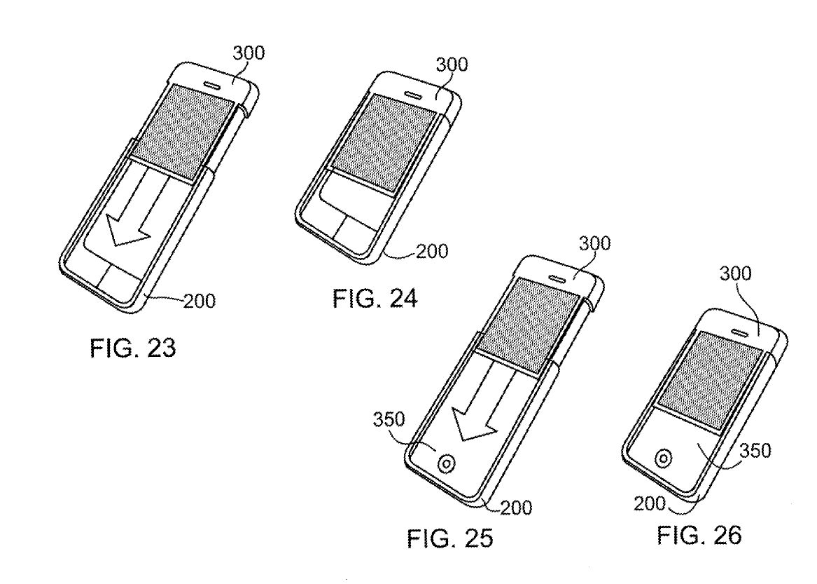

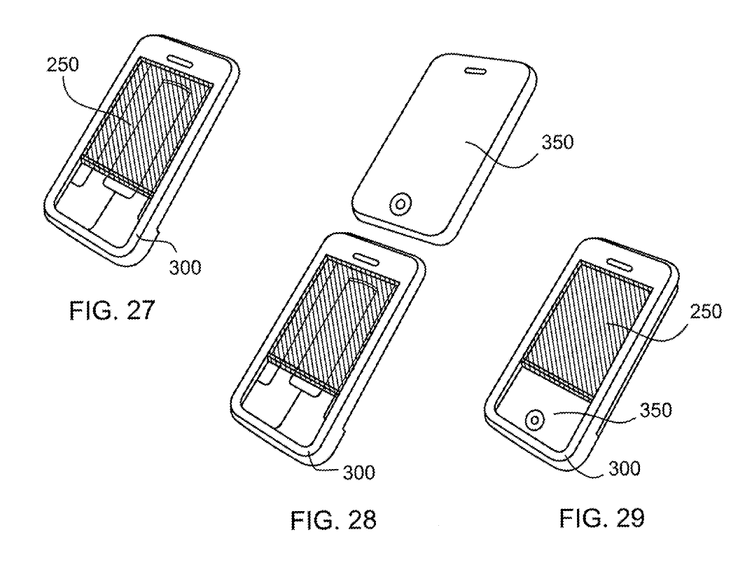

According to embodiments as shown in FIGS. 2 and 12 to 33, the autostereoscopic overlay 250, such as a lenticular sheet, may be combined with a protective case which may comprise a protective frame 200 or a protective cover 300 or both to maintain the correct positioning of the autostereoscopic overlay 250 over the display of the mobile device 350. According to an embodiment, the frame 200 may contain a slot in the upper portion of the frame 200 for receiving the lenticular sheet. According to a further embodiment, the cover 300 may contain a slot in the upper portion of the cover 300 for receiving the lenticular sheet.

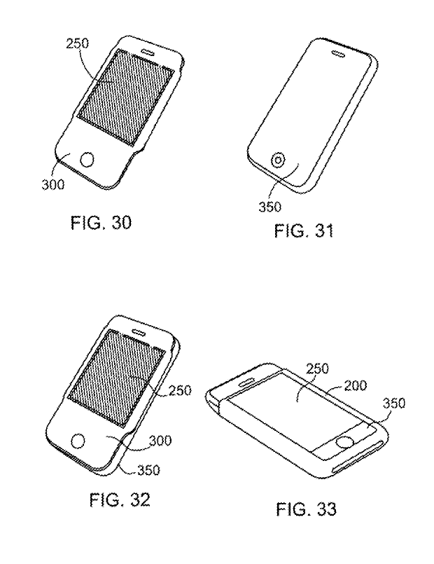

According to an embodiment as shown in FIGS. 30 to 32, the protective case may be made of a stretchable flexible material, such as rubber, which allows the frame 200 or cover 300 or both to adapt to fit different-sized mobile devices 350. Other embodiments for a frame 200 or protective cover 300 and combining a frame 200 or protective cover 300 or both with an autostereoscopic overlay 250 will be appreciated by a person skilled in the art.

3D Loading and Viewing

According to an embodiment of the system, stereo images from a data store such as Image Data Store 70 may be distributed and viewed on mobile devices 350.

Accordingly, an Image Load and Viewing component 80 may search for stereo images in a data store such as Image Data Store 70. If the loaded stereo image is already interlaced it may be displayed immediately. If the stereo image comes in a device-independent format such as side-by-side, it may be interlaced by the 3D interlacing tool described above at 3D Interlacing component 50.

According to an embodiment, the Image Load and Viewing component 80 may use a command area on the display to walk through a gallery of images in the data store such as Image Data Store 70. Gestures like left or right sliding may instruct the Image Load and Viewing component 80 to step forward or backward in the set of stereo images. According to an embodiment, the command area may also allow adapting the Image Load and Viewing component 80 to the local language of the user 10.

Many of the functions and features associated with the mobile device as described above in accordance with the embodiments may be implemented in the form of one or more software objects, components, or computer programs or program modules in the mobile device and/or the data store. Further, at least some or all of the software objects, components or modules may be hard-coded into processing units and/or read only memories or other non-volatile storage media in the mobile device and/or other components or modules. The specific implementation details of the software objects and/or program modules will be within the knowledge and understanding of one skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A mobile computing device configured to display a stereoscopic image to a user, comprising:
a screen;
an autostereoscopic overlay over at least a portion of the screen;
a processor;
a computer-readable memory; and
computer-readable instructions stored on the computer-readable memory which when executed by the processor display an interlaced image to the screen such that the interlaced image appears to the user as the stereoscopic image when the screen is viewed through the autostereoscopic overlay.

2. The device of claim 1, wherein the computer readable instructions include instructions for processing two images to generate the interlaced image.

3. The device of claim 2, wherein the two images comprises a left image and a right image.

4. The device of claim 3, wherein the left image and right image are manually aligned by the user.

5. The device of claim 4, wherein the mobile computing device comprises a touch screen interface which is used by the user to manually align the left image and the right image.

6. The device of claim 1, wherein the mobile computing device comprises a camera.

7. The device of claim 1, wherein the mobile computing device comprises a touch screen interface.

8. The device of claim 1, wherein the autostereoscopic overlay comprises a lenticular sheet.

9. The device of claim 1, wherein the autostereoscopic overlay is secured over the screen of the mobile computing device by a case.

10. The device of claim 9, wherein the case comprises a frame.

11. The device of claim 9, wherein the case comprises a protective cover for the screen.

12. A kit for enabling the display of stereoscopic images on a mobile computing device comprising a screen, a processor and a computer-readable memory containing computer-readable instructions which when executed by the processor display an interlaced image to the screen such that the interlaced image appears to the user as a stereoscopic image when the screen is viewed through an autostereoscopic overlay, comprising:
the autostereoscopic overlay for the mobile computing device; and
a case for securing the autostereoscopic overlay over at least a portion of the screen of the mobile computing device.

13. The kit of claim 14, wherein the case includes a protective cover for the screen.

14. A method for using a mobile computing device to generate and display an interlaced image so that it appears as a stereoscopic image when viewed through an autostereoscopic overlay by a user of the mobile computing device, the mobile computing device comprising a screen, a processor, a computer-readable memory and an autostereoscopic overlay secured over at least a portion of the screen, comprising:
capturing two images;
interlacing the two images so that the interlaced image will appear as a stereoscopic image when viewed through an autostereoscopic overlay; and
displaying the interlaced image to the screen of the mobile device.

15. The method of claim 14, further comprising the step of aligning the two images.

16. The method of claim 14, wherein the two images are captured by a camera on the mobile device.
